(19) United States
(12) Patent Application Publication
(10) Pub. No.: US 2005/0110791 A1
(43) Pub. Date: May 26, 2005

(54) Systems and methods for segmenting and displaying tubular vessels in volumetric imaging data

(76) Inventors: Prabhu Krishnamoorthy, Plymouth, MN (US); Annapoorani Gothandaraman, Iselin, NJ (US); Marek Brejl, Eden Prairie, MN (US); Vincent Argiro, Minneapolis, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/723,445

(22) Filed: Nov. 26, 2003

(51) Int. Cl. G06T 17/00

(52) U.S. Cl. 345/419; 345/424

(57) ABSTRACT

This document discusses, among other things, systems and methods for segmenting and displaying blood vessels or other tubular structures in volumetric imaging data. The vessel of interest is specified by user input, such as by using a single point-and-click of a mouse or using a menu to select the desired vessel. A central vessel axis (CVA) or centerline path is obtained. A segmentation algorithm uses the centerline to propagate a front that collects voxels associated with the vessel. Re-initialization of the algorithm permits control parameter(s) to be adjusted to accommodate local variations at different parts of the vessel. Termination of the front occurs, among other things, upon vessel departure, for example, indicated by a speed of front evolution falling below a predetermined threshold. After segmentation, an analysis view displays on a screen a 3D rendering of an organ or region, along with orthogonal lateral views of the vessel of interest, and cross-sectional views taken perpendicular to the centerline, which has been corrected using the segmented volumetric vessel data. Cross-sectional diameters are measured automatically, or using a computer-assisted ruler, to permit assessment of stenosis and/or aneurysms. The segmented vessel may also be displayed with a color-coding to indicate its diameter.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2003, Vital Images, Inc. All Rights Reserved.

### TECHNICAL FIELD

This patent application pertains generally to computerized systems and methods for processing and displaying three dimensional imaging data, and more particularly, but not by way of limitation, to computerized systems and methods for segmenting tubular structure volumetric data from other volumetric data.

### BACKGROUND

Because of the increasingly fast processing power of modern-day computers, users have turned to computers to assist them in the examination and analysis of images of real-world data. For example, within the medical community, radiologists and other professionals who once examined x-rays hung on a light screen now use computers to examine images obtained via ultrasound, computed tomography (CT), magnetic resonance (MR), ultrasonography, positron emission tomography (PET), single photon emission computed tomography (SPECT), magnetic source imaging, and other imaging modalities. Countless other imaging techniques will no doubt arise as medical imaging technology evolves.

Each of these imaging procedures uses its particular technology to generate volume images. For example, CT uses an x-ray source that rapidly rotates around a patient. This typically obtains hundreds of electronically stored pictures of the patient. As another example, MR uses radio-frequency waves to cause hydrogen atoms in the water content of a patient's body to move and release energy, which is then detected and translated into an image. Because each of these techniques penetrates the body of a patient to obtain data, and because the body is three-dimensional, the resulting data represents a three-dimensional image, or volume. In particular, CT and MR both typically provide three-dimensional “slices” of the body, which can later be electronically reassembled into a composite three-dimensional image.

Computer graphics images, such as medical images, have typically been modeled through the use of techniques such as surface rendering and other geometric-based techniques. Because of known deficiencies of such techniques, volume-rendering techniques have been developed as a more accurate way to render images based on real-world data. Volume-rendering takes a conceptually intuitive approach to rendering. It assumes that three-dimensional objects are composed of basic volumetric building blocks.

These volumetric building blocks are commonly referred to as voxels. Such voxels are a logical extension of the well known concept of a pixel. A pixel is a picture element—i.e., a tiny two-dimensional sample of a digital image at a particular location in a plane of a picture defined by two coordinates. Analogously, a voxel is a sample, sometimes referred to as a “point,” that exists within a three-dimensional grid, positioned at coordinates x, y, and z. Each voxel has a corresponding “voxel value.” The voxel value represents imaging data that is obtained from real-world scientific or medical instruments, such as the imaging modalities discussed above. The voxel value may be measured in any of a number of different units. For example, CT imaging produces voxel intensity values that represent the density of the mass being imaged, which may be represented using Hounsfield units, which are well known to those of ordinary skill within the art.

To create an image for display to a user, a given voxel value is mapped (e.g., using lookup tables) to a corresponding color value and a corresponding transparency (or opacity) value. Such transparency and color values may be considered attribute values, in that they control various attributes (transparency, color, etc.) of the set of voxel data that makes up an image.

In summary, using volume-rendering, any three-dimensional volume can be simply divided into a set of three-dimensional samples, or voxels. Thus, a volume containing an object of interest is dividable into small cubes, each of which contain some piece of the original object. This continuous volume representation is transformable into discrete elements by assigning to each cube a voxel value that characterizes some quality (e.g., density, for a CT example) of the object as contained in that cube.

The object is thus summarized by a set of point samples, such that each voxel is associated with a single digitized point in the data set. As compared to mapping boundaries in the case of geometric-based surface-rendering, reconstructing a volume using volume-rendering requires much less effort and is more intuitively and conceptually clear. The original object is reconstructed by the stacking of voxels together in order, so that they accurately represent the original volume.

Although more simple on a conceptual level, and more accurate in providing an image of the data, volume-rendering is nevertheless still quite complex. In one method of voxel rendering, called image ordering or ray casting, the volume is positioned behind the picture plane, and a ray is projected from each pixel in the picture plane through the volume behind the pixel. As each ray penetrates the volume, it accumulates the properties of the voxels it passes through and adds them to the corresponding pixel. The properties accumulate more quickly or more slowly depending on the transparency/opacity of the voxels.

Another method, called object-order volume rendering, also combines the voxel values to produce image pixels displayed on a computer screen. Whereas image-order algorithms start from the image pixels and shoot rays into the volume, object-order algorithms generally start from the volume data and project that data onto the image plane.

One widely used object-order algorithm uses dedicated graphics hardware to perform the projection of the voxels in a parallel fashion. In one method, the volume data is copied into a 3D texture image. Then, slices perpendicular to the viewer are drawn. On each such slice, the volumetric data is resampled. By drawing the slices in a back-to-front fashion and combining the results using a well-known technique called compositing, the final image is generated. The image rendered in this method also depends on the transparency of the voxels.

One problem, in addition to such volume rendering and display, is data segmentation. Data segmentation refers to extracting data pertaining to one or more structures or regions of interest (i.e., “segmented data”) from imaging data that includes other data that does not pertain to such one or more structures or regions of interest (i.e., “non-segmented data.”) As an illustrative example, a cardiologist may be interested in viewing only 3D image of certain coronary vessels. However, the raw image data typically includes the vessels of interest along with the nearby heart and other thoracic tissue, bone structures, etc. Segmented data can be used to provide enhanced visualization and quantification for better diagnosis. For example, segmented and unsegmented data could be volume rendered with different attributes. Therefore, the present inventors have recognized a need in the art for improvements in 3D data segmentation and display, such as to improve speed, accuracy, and/or ease of use for diagnostic or other purposes.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating generally, among other things, one example of portions of an imaging visualization system, and an environment with which it is used, for processing and displaying volumetric imaging data of a human or animal or other subject or any other imaging region of interest.

FIG. 2 is a schematic illustration of one example of a remote or local user interface.

FIG. 3 is a flow chart illustrating generally, among other things, one example of a technique of using the system for segmenting and visualizing volumetric imaging data.

FIG. 4 is a screenshot illustrating generally one example of the analysis view of the segmented data, which is displayed on the user interface display.

FIG. 5 is a flow chart illustrating generally, among other things, one example of an algorithm that, using a single input, tracks and segments a vessel.

FIG. 6 is a flow chart illustrating generally, among other things, one example of an algorithm that, using a single input, tracks and segments a vessel, and which further includes a re-initialization of the process and end processing of the obtained data.

FIG. 7 is a flow chart illustrating generally, among other things, one example of an overview of a process of extracting a central vessel axis (CVA) path or centerline, and allowing for one or more termination criteria.

FIG. 8 is a flow chart illustrating generally, among other things, one example of CVA extraction, including a user-based input of the path and/or an automatic input of the path.

FIG. 9 is a flow chart illustrating generally, among other things, one example of CVA extraction, including a user-based and/or automatic input of the path, and various preliminary processes to enhance extraction speed and efficiency.

FIG. 10 is a flow chart illustrating generally, among other things, one example of tracking the vessel from a seed point bi-directionally through the vessel.

FIG. 11 is a flow chart illustrating generally, among other things, one example of the steps of tracking the vessel from a seed point bi-directionally through the vessel until vessel departure is detected.

FIG. 12 is a flow chart illustrating generally, among other things, one example of segmenting a vessel, and allowing the process to terminate based upon a pre-defined condition.

FIG. 13 is a flow chart illustrating generally, among other things, one example of centering within a vessel two end points of a path and a seed point.

FIG. 14 is a flow chart illustrating generally, among other things, one example of centering a path.

FIG. 15 is a flow chart illustrating generally, among other things, one example of the detecting when vessel departure has occurred.

FIG. 16 is a schematic illustration of one example of front propagation through a vessel.

FIG. 17 is a schematic illustration of one example illustrating how larger values of dₛₜₒₚ can cause errors in path calculation, which illustrates a need for path centering using the segmented vessel data.

FIG. 18 is a schematic illustration of one example of a vessel path passing from a tubular structure to a non-tubular structure.

FIG. 19 is a graph illustrating the variations of an attribute (dₘₐₓ) as the front propagates through a tubular structure.

FIG. 20 is a graph demonstrating one example of the change in one attribute (dₘₐₓ) of a front propagating through a non-tubular structure.

FIG. 21 is a schematic illustration of an example of a list of points along a calculated centerline where the line passing through them describes an angle ?ᵥ.

FIG. 22 is an illustration of an example of determining the portion of a candidate CVA segment that is new with respect to a cumulative CVA.

### DETAILED DESCRIPTION

In the following detailed description, reference is made to the accompanying drawings which form a part hereof, and in which is shown by way of illustration specific embodiments in which the invention may be practiced. These embodiments, which are also referred to herein as “examples,” are described in sufficient detail to enable those skilled in the art to practice the invention, and it is to be understood that the embodiments may be combined, or that other embodiments may be utilized and that structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconcilable inconsistencies, the usage in this document controls.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In this document, the term “vessel” refers not only to blood vessels, but also includes any other generally tubular structure (e.g., a colon, etc.).

1. System Overview

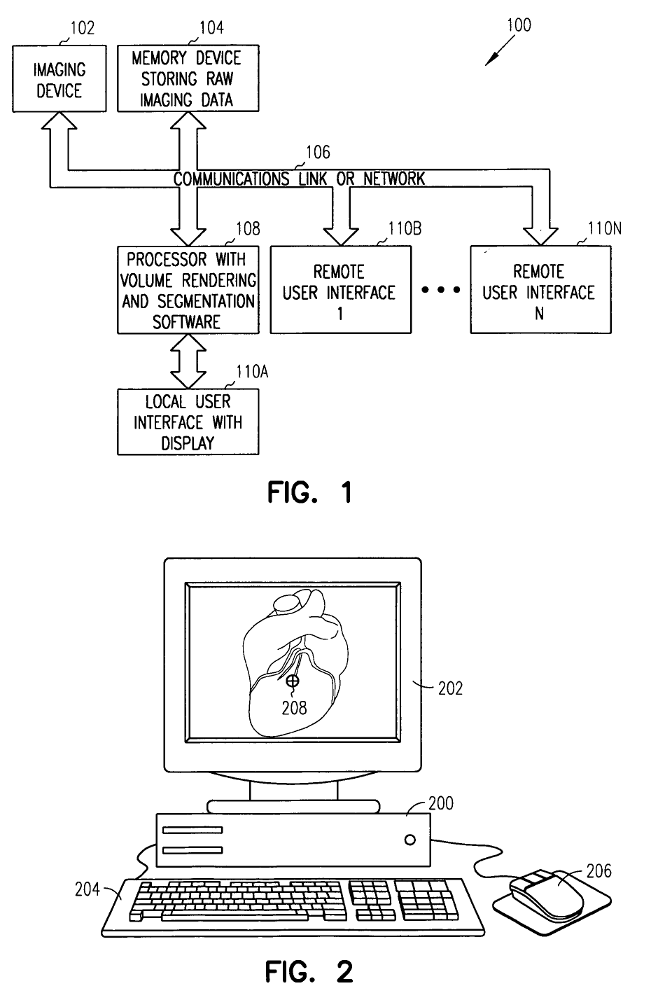

FIG. 1 is a block diagram illustrating generally, among other things, one example of portions of an imaging visualization system 100, and an environment with which it is used, for processing and displaying volumetric imaging data of a human or animal or other subject or any other imaging region of interest. In this example, the system 100 includes (or interfaces with) an imaging device 102. Examples of the imaging device 102 include, without limitation, a computed tomography (CT) scanner or a like radiological device, a magnetic resonance (MR) imaging scanner, an ultrasound imaging device, a positron emission tomography (PET) imaging device, a single photon emission computed tomography (SPECT) imaging device, a magnetic source imaging device, and other imaging modalities. Countless other imaging techniques and devices will no doubt arise as medical imaging technology evolves. Such imaging techniques may employ a contrast agent to enhance visualization of portions of the image (for example, a contrast agent that is injected into blood carried by blood vessels) with respect to other portions of the image (for example, tissue, which does not include such a contrast agent). For example, in CT images, bone voxel values typically exceed 600 Hounsfield units, tissue voxel values are typically less than 100 Hounsfield units, and contrast-enhanced blood vessel voxel values fall somewhere between that of tissue and bone.

In the example of FIG. 1, the system 100 also includes one or more computerized memory devices 104, which is coupled to the imaging device 102 by a local and/or wide area computer network or other communications link 106. The memory device 104 stores raw volumetric imaging data that it receives from the imaging device 102. Many different types of memory devices will be suitable for storing the raw imaging data. A large volume of data may be involved, particularly if the memory device 104 is to store data from different imaging sessions and/or different patients.

One or more computer processors 108 are coupled to the memory device 104 through the communications link 106 or otherwise. The processor 108 is capable of accessing the raw imaging data that is stored in the memory device 104. The processor 108 executes software that performs data segmentation and volume rendering. The data segmentation extracts data pertaining to one or more structures or regions of interest (i.e., “segmented data”) from imaging data that includes other data that does not pertain to such one or more structures or regions of interest (i.e., “non-segmented data.”). In one illustrative example, but not by way of limitation, the data segmentation extracts images of underlying tubular structures, such as coronary or other blood vessels (e.g., a carotid artery, a renal artery, a pulmonary artery, cerebral arteries, etc.), or a colon or other generally tubular organ. Volume rendering depicts the segmented and/or unsegmented volumetric imaging data on a two-dimensional display, such as a computer monitor screen.

In one example, the system 100 includes one or more local user interfaces 110A, which are locally coupled to the processor 108, and/or one or more remote user interfaces 110B-N, which are remotely coupled to the processor 108, such as by using the communications link 106. Thus, in one example, the user interface 110A and processor 108 form an integrated imaging visualization system 100. In another example, the imaging visualization system 100 implements a client-server architecture with the processor(s) 108 acting as a server for processing the raw volumetric imaging data for visualization, and communicating graphic display data over the communications link 106 for display on one or more of the remote user interfaces 110B-N. In either example, the user interface 110 includes one or more user input devices (such as a keyboard, mouse, web browser, etc.) for interactively controlling the data segmentation and/or volume rendering being performed by the processor(s) 108, and the graphics data being displayed.

FIG. 2 is a schematic illustration of one example of a remote or local user interface 110. In this example, the user interface 110 includes a personal computer workstation 200 that includes an accompanying monitor display screen 202, keyboard 204, and mouse 206. In an example in which the user interface 110 is a local user interface 111A, the workstation 200 includes the processor 108 for performing data segmentation and volume rendering for data visualization. In another example, in which the user interface 110 is a remote user interface 110B-N, the client workstation 200 includes a processor that communicates over the communications link 106 with a remotely located server processor 108.

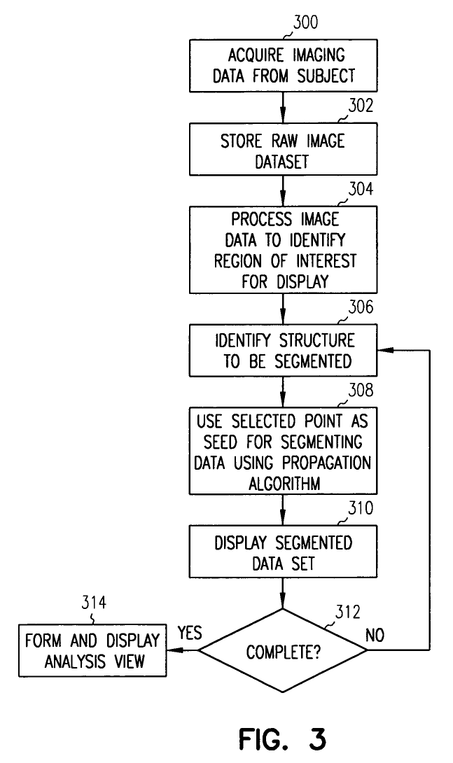

FIG. 3 is a flow chart illustrating generally, among other things, one example of a technique of using the system 100 for segmenting and visualizing volumetric imaging data. At 300, imaging data is acquired from a human, animal, or other subject of interest. In one example, this act includes using one of the imaging modalities discussed above. At 302, the volumetric raw imaging data is stored. In one example, this act includes storage in a network-accessible computerized memory device, such as memory device 104.

At 304, the raw image data is processed to identify a region of interest for display. The particular region of interest may be specified by the user. An illustrative example is depicted on the display 202 of FIG. 2, which illustrates a 3D rendering of a heart that has been extracted from raw imaging data that includes other thoracic structures. Other regions of interest may include a different organ, such as a kidney, a liver, etc., a different region (e.g., an abdomen, etc.) that may include more than one organ, and/or regions of muscle or tissue. This extraction is itself a form of data segmentation. In the heart example, the heart is surrounded by the lungs and the bones forming the chest cavity. In a CT image data set, the air-filled lungs typically exhibit a relatively low density and the bones forming the chest cavity typically exhibit a relatively high density. The heart tissue of interest typically falls therebetween. Therefore, by imposing lower and upper thresholds on the voxel values, and additional geometric constraints, the heart tissue voxels can be segmented from the surrounding thoracic voxel data.

In one example, the act of processing the raw image data to identify a region of interest for display includes reducing the data set to eliminate data that is deemed “uninteresting” to the user, such as by using the systems and methods described in Zuiderveld U.S. patent application Ser. No. 10/155,892, entitled OCCLUSION CULLING FOR OBJECT-ORDER VOLUME RENDERING, which was filed on May 23, 2002, and which is assigned to Vital Images, Inc., and which is incorporated by reference herein in its entirety, including its disclosure of computerized systems and methods for providing occlusion culling for efficiently rendering a three dimensional image.

At 306, user input is received to identify a particular structure to be segmented (that is, extracted from other data). In one example, the act of identifying the structure to be segmented is responsive to a user using the mouse 206 to position a cursor 208 over a structure of interest, such as a coronary or other blood vessel, as illustrated in FIG. 2, or any other tubular structure. By clicking the mouse 206 at a single location on the screen 202, the user interface 110 captures the screen coordinates of the cursor 208 that corresponds to the coronary vessel (or other tubular structure) that the user desires to segment from other data. This user-selected 2D screen location is mapped into the dataset of the displayed region of interest and, at 308, is used as an initial seed location in the volumetric imaging data for initiating a volumetric segmentation algorithm. In one example, the initial seed location can alternatively be automatically initialized, such as by scanning and determining which points are likely to be vessel points (e.g., based on an initial contrast reading, etc.) and initializing at one or more such points. In one example, this mapping of the cursor position from the 2D screen image to a 3D location within the volumetric imaging data is performed using known ray-casting techniques.

One example of a segmentation algorithm for extracting tubular volumetric data is described in great detail below, and is therefore only briefly discussed here. The particular segmentation algorithm typically balances accuracy and speed. In one example, the segmentation algorithm generally propagates outward from the initial seed location. For example, if the seed location is in a midportion of the approximately cylindrical vessel, the segmentation algorithm then propagates in two opposite directions of the tubular vessel structure being segmented. In another example, if the seed location is at one end of the approximately cylindrical vessel (such as where a blood vessel opens into a heart chamber, etc.), the segmentation algorithm then propagates in a single direction (e.g., in the direction of the vessel away from the heart chamber). In yet another example, if the seed location is at a Y-shaped branch point of the approximately cylindrical vessel, the segmentation algorithm then propagates in the three directions comprising the Y-shaped vessel.

At 310, the segmented data set is displayed on the user interface 110. In one example, the act of displaying the segmented data at 310 includes displaying the segmented data (e.g., with color highlighting or other emphasis) along with the non-segmented data. In another example, the act of displaying the segmented data at 310 includes displaying only the segmented data (e.g., hiding the non-segmented data). In a further example, a user-selectable parameter determines whether the segmented data is displayed alone or together with the non-segmented data, such as by using a web browser or other user input device portion of the user interface 110.

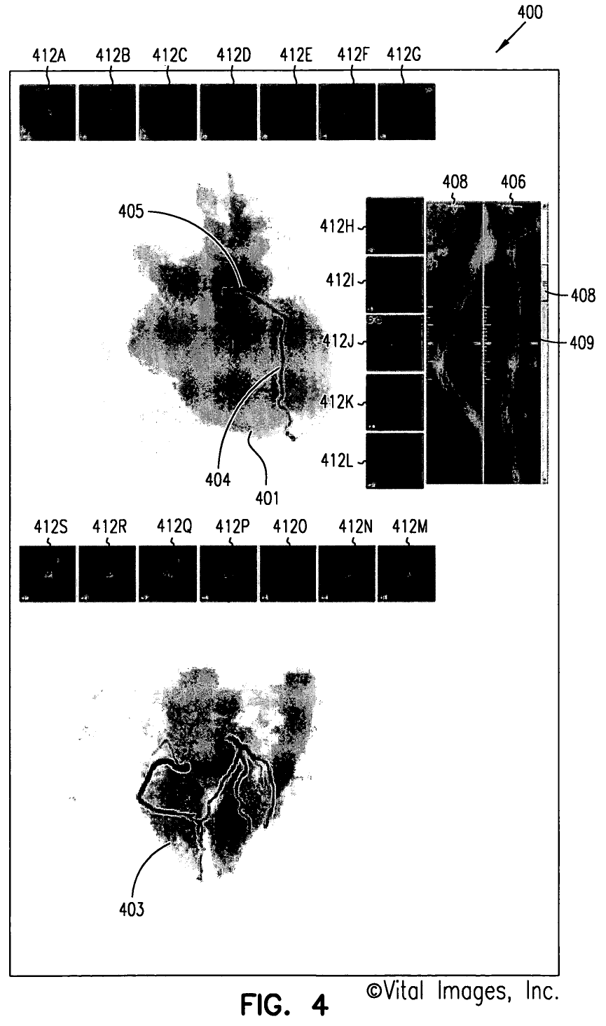

At 312, if the user deems the displayed segmented data set to be complete, then the user can switch to display an “analysis” view of the segmented data, as discussed below and illustrated in FIG. 4. Otherwise, process flow returns to 305, which permits the user to perform a single point-and-click of a mouse to select an additional seed. The additional seed triggers further data segmentation using the propagation algorithm. This permits another “branch” to be added to the segmented data vessel “tree.”

2. Analysis View

FIG. 4 is a screenshot illustrating generally one example of the analysis view 400 of the segmented data, which is displayed on the user interface display 202. In this example, a top portion of the view 400 displays a 3D depiction 401 of the region of interest, such as the heart 402 (or other organ or region), before the vessel segmentation has been performed. A bottom portion of the view 400 displays a 3D depiction 403 of the region of interest, such as the heart 402 (or other organ or region), after the vessel segmentation has been performed. In one example, the 3D depiction 403 displays the segmented vessel 404 as colored, highlighted, or otherwise emphasized to call attention to it. For example, the segmented vessel 404 may be depicted as being relatively opaque in appearance and the surrounding heart tissue may be depicted as being relatively transparent in appearance. In one example, the display 202 includes a user-movable cursor 405 that tracks within the segmented vessel 404 in one or both of the 3D depictions 401 and 403.

In this example, the top portion of the view 400 also includes an inset first lateral view 406 of a portion of the segmented vessel 404. The first lateral view 406 is centered about a position that corresponds to the position of the segmented vessel-tracking cursor that is displayed in the 3D depiction 401. Along a side of first lateral view 406 is an inset second lateral view 408 of the segmented vessel 404. The second lateral view 408 is similarly centered about a position that corresponds to the position of the segmented vessel-tracking cursor that is displayed in the 3D depiction 401.

In this example, the first lateral view 406 is taken perpendicularly to the second lateral view 408. This permits the user to view the displayed portion of the segmented vessel 404 from two different (e.g., orthogonal) directions. A user-slidable button 408 is associated with the window of the first lateral view 406. The user-slidable button 408 moves the cursor displayed in the 3D depiction 401 longitudinally along the segmented vessel 404. Such movement also controls which subportion of the segmented vessel 404 is displayed in the windows of each of the first lateral view 406 and the second lateral view 408.

In the example illustrated in FIG. 4, the first lateral view 406 and the second lateral view 408 are 2D views of reformatted 3D volumetric image data underlying the depicted images 401 and 403. In one example, this reformatting from 3D voxel data to the 2D lateral views is performed using curved planar reformation techniques. In one example, the curved planar reformation operates upon a 3D centerline of the segmented blood vessel of interest. For example, a corrected 3D centerline is provided by the segmentation algorithm discussed below. The curved planar reformation uses Principal Components Analysis (PCA) on the centerline of the generally tubular segmented vessel structure. In the example of FIG. 4, the PCA is used to orient the viewing direction of the first lateral view 406 such that the vessel data then being displayed in the window of the first lateral view exhibits a substantially minimum amount of curvature in the longitudinal direction of its elongated display window. This can be accomplished by using the eigen vector (provided by the PCA) that corresponds to the smallest eigen value.

The second lateral view 408 is taken orthogonal to the viewing direction of the first lateral view 406, as discussed above, and does not seek to reduce or minimize the amount of curvature in its elongated display window. For each of the first lateral view 406 and the second lateral view 408, the displayed image of the segmented blood vessel is formed, in one example, by traversing the points of the centerline of the segmented vessel and collecting voxels that are along a scan line that runs through the centerline point and that are perpendicular to the direction from which the viewer looks at that particular lateral view. To reduce or avoid curved view errors (e.g., due to an error in the centerline obtained from the segmentation algorithm), maximum intensity projection (MIP) or multi-planar reconstruction (MPR) techniques (e.g., thick MPR or average MPR) can be used instead of a single scan line through the centerline.

Each of the windows of the first lateral view 406 and the second lateral view 408 is centered at 409 about a graduated scale of markings. These markings are separated from each other by a predetermined distance (e.g., 1 mm). It is the centermost marking on this scale that corresponds to the position of the segmented vessel-tracking cursor that is displayed in the 3D depiction 401. Substantially each of the markings corresponds to an inset cross-sectional view 412 (i.e., perpendicular to both the first lateral view 406 and the second lateral view 408) of the segmented vessel 404 taken at that marking (and orthogonal to the centerline of the segmented vessel at that marking). The particular example illustrated in FIG. 4 includes nineteen such cross-sectional views corresponding to nineteen markings (in this particular example, the endmost markings, each representing a distance of 10 mm from the centermost marking, do not have corresponding cross-sectional views). These cross-sectional views 412 permit the user to quantitatively evaluate the degree of occlusion of the segmented vessel. In one example, the system provides a displayable and computer-manipulable “ruler” tool, such as to measure cross-sectional vessel diameter to assess stenosis. In this manner, presenting such cross-sectional views 412 together with the cursor-centered orthogonal lateral views 406 and 408, the 3D depiction 401 of the region of interest, and/or the segmented vessel tracking cursor (and subcombinations of these features) greatly assists the user in diagnosing occlusion and planning surgical or other intervention or other corrective action.

3. CVA Extraction and Tubular Data Segmentation

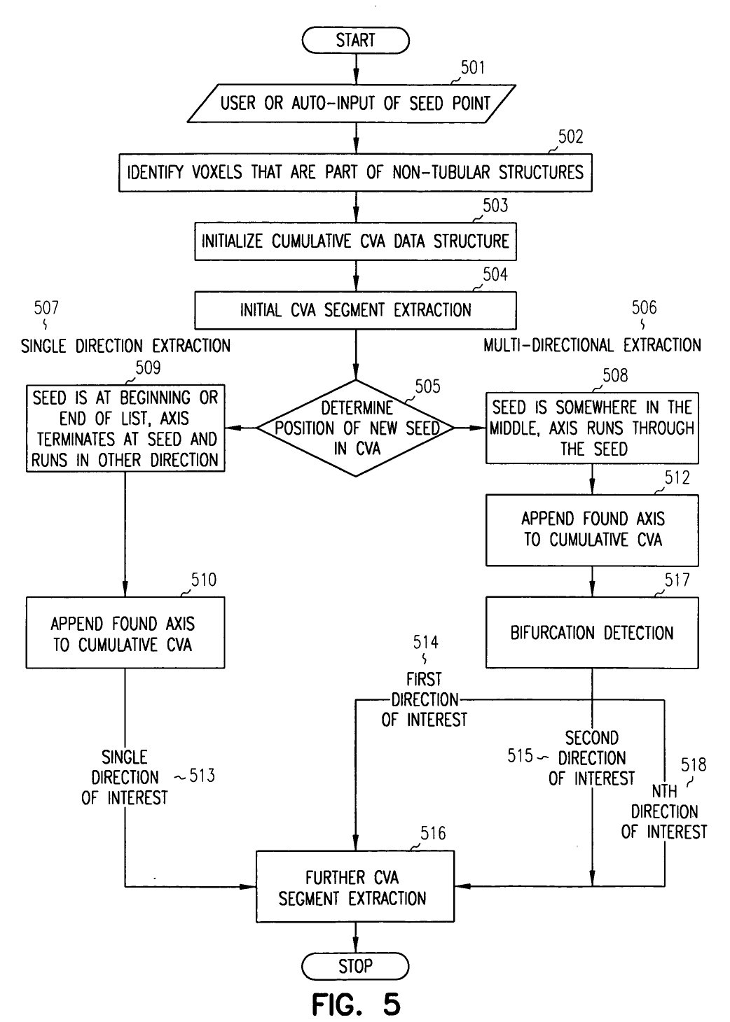

FIG. 5 is a flow chart illustrating generally an overview example of a data segmentation process for extracting (in the 3D space of the imaging data) a central vessel axis (CVA) of any tubular structure. In one example, the CVA uses a defined single seed point from which to extract an initial CVA segment and any further CVA incremental segment(s), as discussed below. The CVA is sometimes referred to as a centerline, however, this centerline is typically a curved line in the 3D imaging space. Similarly, though the term central vessel axis refers to an axis, the axis need not be (and is typically not) a straight line.

At 501, a single seed point for performing the CVA extraction is defined. In one example, this act includes receiving user input to define the single seed point. In another example, this act includes using a seed point that is automatically defined by the computer implemented CVA algorithm itself, such as by using a result of one or more previous operations in the CVA process, or from an atlas or prior model.

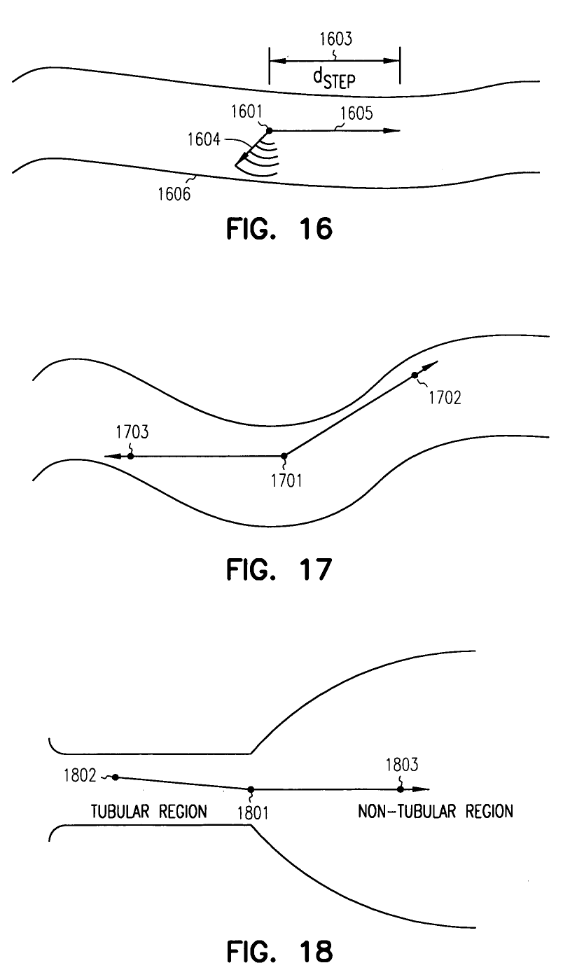

At 502, each voxel that is part of non-tubular structure is identified so that it can be eliminated from further consideration, so as to accelerate the CVA extraction process, and to reduce the memory requirements for computation. In one example, this is accomplished by utilizing an atlas of the human body to identify the non-tubular structures. At 503, a list or other data structure that is designated to store the cumulative CVA data is initialized, such as to an empty list. At 504, an initial CVA incremental segment extraction is performed using the initial single seed point, as discussed in more detail below with respect to FIG. 16. In one example, the initial CVA incremental segment extraction provides an initial axis segment from or through the initial single seed point. This incremental axis segment, which is stored in the list (or other data structure) defines direction(s) of interest from the seed point.

At 505, a determination is made of the position of the defined initial seed point on the initial CVA incremental axis segment. At 508, if the seed is located somewhere in the middle of the list representing the initial CVA incremental axis segment, then the initial CVA incremental axis segment runs through the initial seed. This yields at least two potential search directions for extracting the cumulative CVA segment further outward from the initial CVA incremental axis segment. Such further extending the CVA extraction can use both of the endpoints of the initial CVA incremental axis segment and seeds for further CVA extraction at 516. However, if at 509 the seed is located at the beginning or end of the list corresponding to the initial CVA incremental axis segment, then the initial CVA incremental axis segment terminates at the seed and extends outward therefrom. This may result from, among other things, a vessel branch that terminates at the initial seed, or a failure in the initial CVA extraction step. In such a case, further extending the CVA extraction can use the single endpoint as a seed for further CVA extraction at 516.

After determining the directions of interest of the CVA relative to the initial seed, the initially extracted CVA incremental segment data is appended to the cumulative CVA data at 510 or 512. This provides a non-empty list to which further CVA results may later be appended. At 508, if the initial seed is located somewhere in the middle of the initial CVA incremental segment data, then the search and extraction process proceeds in two directions of interest at 514 and 515. In one example, this further extraction proceeds serially, e.g. one direction at a time. In another example, this further example proceeds in parallel, e.g. extracting both directions of interest concurrently. At 509, if the initial seed is located at the beginning or end of the initial CVA incremental segment data, further CVA extraction proceeds in only one direction at 513.

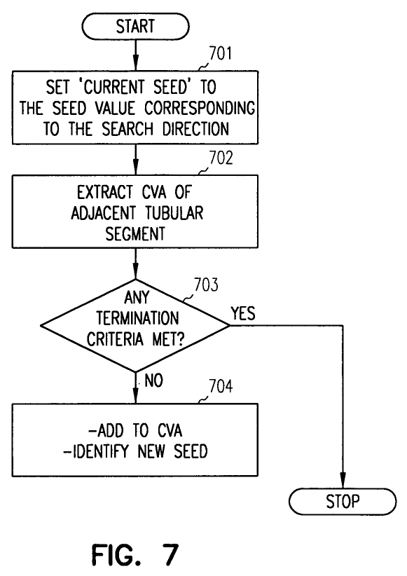

In this way, using the end point(s) of the initial CVA incremental segment extraction at 504 as new seed points for further extraction, further CVA incremental segments are then extracted at 516 along the direction(s) of interest until one or more termination criteria are met. This CVA “propagation” (by which additional CVA incremental segments are added to the cumulative CVA) is further described below, such as with respect to FIG. 7. When a termination criterion is met, the propagation stops, and the cumulative calculated CVA is available.

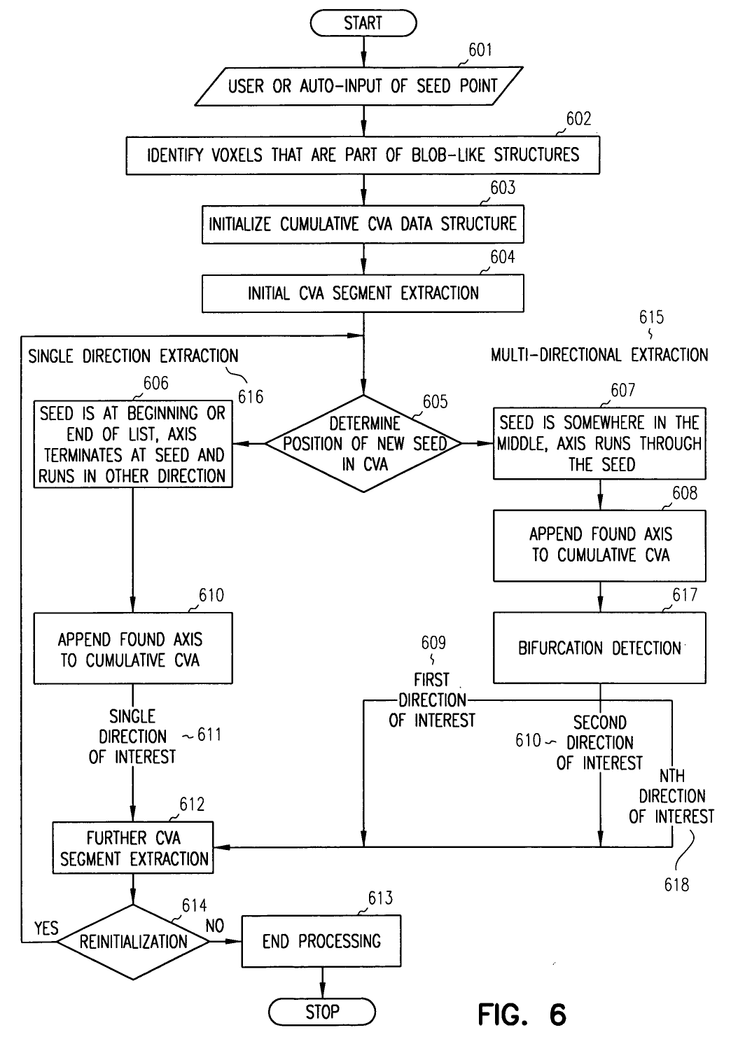

FIG. 6 is flow chart illustrating generally, among other things, another overview example of a CVA extraction. In this example, at 601, a single initial seed point is selected from which to initiate CVA extraction of a particular vessel, such as for subsequent visualization display for an end user. In one example, the single seed point is selected at 601 by the user, such as by using a mouse cursor or any of a variety of other selecting devices and/or techniques. In another example, the single seed point is selected at 601 at the end of prior CVA extraction processing, such as to enable further CVA extraction of the vessel.

In this example, after a single initial seed point is selected at 601, then, at 602, voxels that are part of non-tubular “blob-like structure(s)” are identified. This identification may use the gray value intensity of the voxel (which, in turn, corresponds to a density, in a CT example). In one example, a voxel is deemed in the “background” if its gray value falls below a particular threshold value. The voxel is deemed to be part of the “blob-like” structure if (1) its gray value exceeds the threshold value and (2) there are no background voxels within a particular threshold distance of that voxel. Therefore, all voxels having gray values that exceed the threshold value are candidates for being deemed points that are within a “blob-like” structure. These candidate voxels include all voxels that represent bright objects, such as bone mass, tissue, and/or contrast-enhanced vessels.

Because the above example uses only the gray value and the categorization (i.e., as background) of nearby voxels, it does not take into account any topological information for identifying the “blob-like” structures. In a further example, computational efficiency is increased by using such topological information, such as by performing a morphological opening operation to separate thin and/or elongate structures from the list of candidate voxels. A morphological opening operation removes objects that cannot completely contain a structuring element.

At 603, a list or other data structure for storing the CVA data is initialized (e.g., to an empty list). At 604, an initial CVA extraction is performed to extract an initial CVA segment from the imaging data, such as by using the single initial seed that was determined at 601. This provides an initial CVA incremental axis segment representing direction(s) of interest from the initial seed point. At 605, a position of the initial seed point on the initial axis segment is determined. If the initial seed is located somewhere along the middle of the list representing the initial incremental axis segment then, at 607, the initial incremental axis segment passes through the initial seed. This yields two potential search directions for further extraction. Its endpoints may be used as seeds for further CVA extraction. If the seed is located at one of the endpoints of the list then, at 606, the CVA terminates at the seed and extends outward therefrom. There may be a variety of reasons for such a result, as discussed above. In the single direction case, a single endpoint is used as a seed for further CVA extraction at 612.

After determining the direction(s) of interest of the CVA relative to the initial seed, the data representing the initial extracted CVA incremental segment is appended at 608 to the cumulative CVA data. This provides a non-empty list to which further CVA incremental segment data is later appended.

If the initial seed is located at or near the middle of the initial CVA incremental segment, further CVA extraction propagates in two directions of interest, either serially or in parallel, as discussed above. If the initial seed is located at the beginning or end of the data representing the initial CVA incremental segment, further CVA extraction proceeds in only one direction, at 611.

The end point(s) of the initial CVA incremental segment at 604 serve as seed points for further CVA extraction at 612 along the direction(s) of interest until one or more termination criteria is met. In this example, after a termination criteria is met, a decision as to whether to re-initialize the CVA extraction process is made at 612. In one example, the re-initialization decision is initiated by user input. In another example, the re-initialization decision is made automatically, such as by using one or more predetermined conditions. Re-initialization allows the algorithm to adapt parameters, if needed, to robustly handle local intensity or other variations at different locations within the vessel. Such re-initialization advantageously allows the iterative CVA extraction to propagate further than an algorithm in which the algorithm's parameters are fixed for the entire process. For example, one of the parameters that can be adapted is dₛₜₒₚ (i.e. maximum distance of front propagation during an incremental CVA extraction). As the vessel size increases or bifurcates, the condition indicating a vessel departure change as well, such as where a vessel departure is defined as a sudden change in the vessel diameter. Re-initialization reduces or avoids the need for the user to provide additional point-and-click vessel selection inputs to find and track all of the vessel branches of interest.

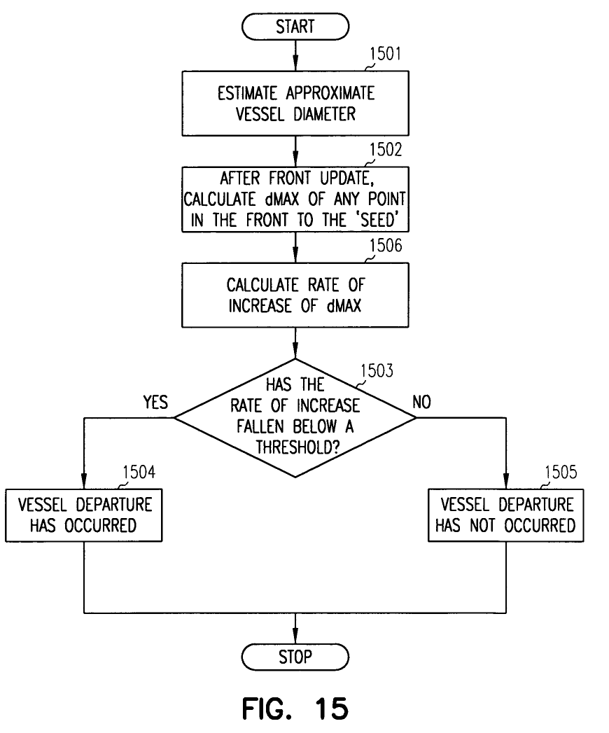

At 614, if re-initialization is selected, process flow returns to 603 to determine at 605 the position of the present seed on the cumulative centerline. Otherwise, if re-initialization is not selected, CVA extraction is completed at 613. In one example, the cumulative extracted CVA further undergoes a volumetric vessel-centering correction, such as described below with respect to FIG. 15. In another example, the cumulative CVA is also smoothed, such as by averaging successive points in the list of CVA data. In yet a further example, an approximate vessel diameter and normal are also estimated at each point on the CVA. The normal may be given by a unit vector from the point on the CVA to the next point on the CVA. The diameter and normal are useful for generating cross-sectional views of the vessel lumen, such as illustrated in FIG. 4. In a further example, a maximum lumen diameter and an average lumen diameter are also calculated for the entire volumetric vessel segment corresponding to the extracted cumulative CVA. In another example, the vessel diameter information is used to automatically flag location(s) of possible stenosis or aneurysm, such as by using a vessel diameter trend, along the vessel, to detect a change in vessel diameter. These threshold values can be computed from an average diameter of the vessel, or using parameters from a vessel-specific profile. In another example, the segmented vessel is displayed with a color coding that represents its effective diameter (e.g., more violet=wider, more red=narrower, or the like). In a further example, the segmented data is displayed in a manner that mimics how a conventional angiogram is displayed, such as described in Andrew Bruss's U.S. patent application Ser. No. 10/679,250, filed on Oct. 3, 2003 (Attorney Docket No. 543.009US1) entitled, “SYSTEMS AND METHODS FOR EMULATING AN ANGIOGRAM USING THREE-DIMENSIONAL DATA,” which is incorporated herein by reference in its entirety, including its description of using 3D image data to emulate an angiogram.

FIG. 7 is a flow chart illustrating generally an example performing further CVA incremental segment extraction, such as illustrated at 516 and 612. In a first pass, the initial seed point(s) from the initial extraction at 501 or 601 are used to set a “current seed” at 701. In subsequent passes, the end point(s) of the preceding CVA incremental segment extraction determine the “current seed” (also referred to as the “seed”) at 701. When there is only one search direction of interest, a single seed is set at 701. When there are two search directions of interest, then a farthest (from the initial seed) one of two endpoints of a previous CVA incremental segment extraction is used to set the seed at 701. Such multidirectional CVA segment extraction may be computed either serially, or in parallel on separate threads of a computing system such as that contemplated by 108 of FIG. 1.

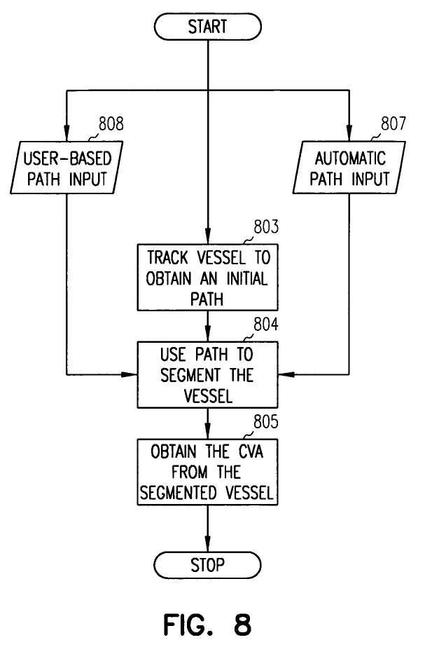

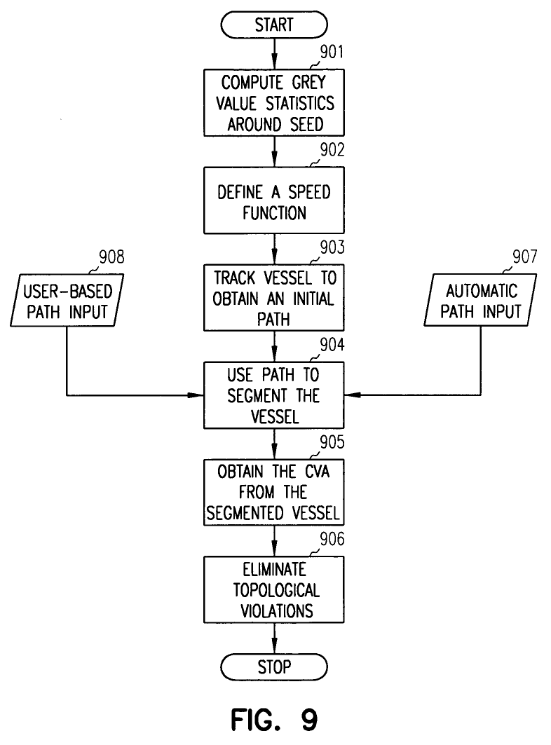

At 702, using the “current seed” and proceeding in the search direction of interest, adjacent further CVA incremental segments are extracted, such as discussed further with respect to FIGS. 8 and 9. At 703, a check is made to determine whether the additional CVA incremental segment extraction met with one or more termination criteria. If no termination criteria were met at 703 then, in one example, at 704, the current CVA incremental segment candidate is examined (e.g., as discussed with respect to FIG. 22) to determine which portion of it is new with respect to the previously extracted cumulative CVA. At 704, the new portion of the candidate CVA incremental segment is appended to the cumulative CVA segment.

Process flow then returns to 701, and the end point of the current CVA incremental segment is then used to set the value of the “current seed” condition for performing another CVA incremental segment extraction. The CVA incremental segment extractions are repeated until one or more termination criteria are met. Examples of termination criteria include, but are not limited to: the search failed to extract a new CVA incremental segment, the search is successful at extracting a new CVA incremental segment but changes direction abruptly (as defined by one or more pre-set conditions), or significant departure of the candidate CVA from the vessel structure (i.e., “vessel departure”) is detected.

FIG. 8 is a flow chart illustrating, by way of example, but not by way of limitation, an overview of exemplary acts associated with tubular data segmentation. This tubular data segmentation extracts voxels that are associated with the volume of the vessel. In one example, it uses the previously extracted CVA centerline path.

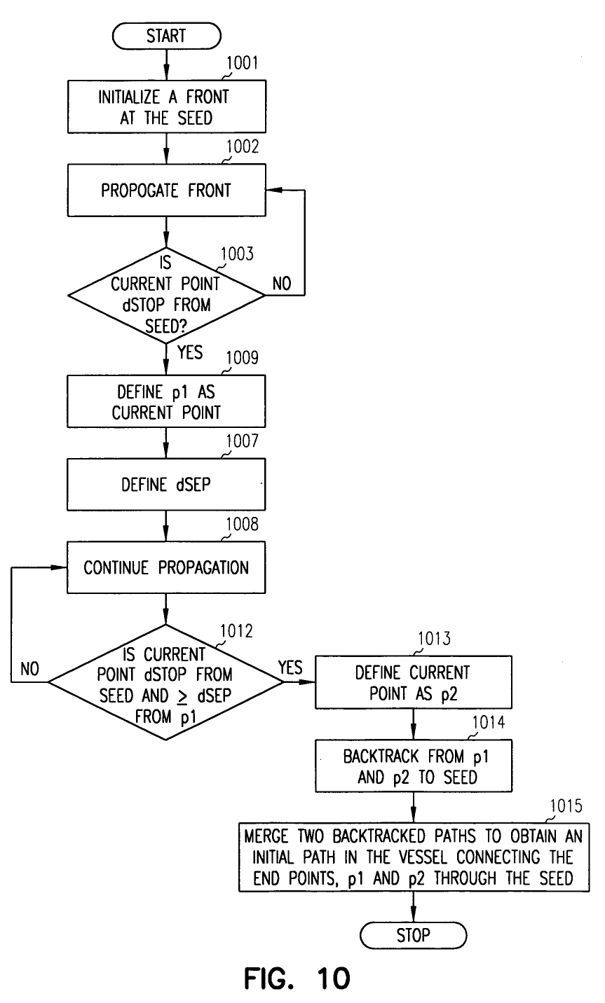

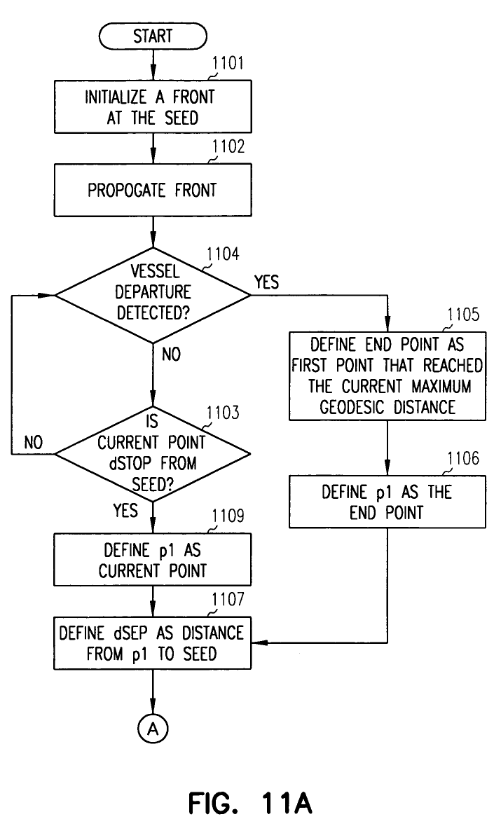

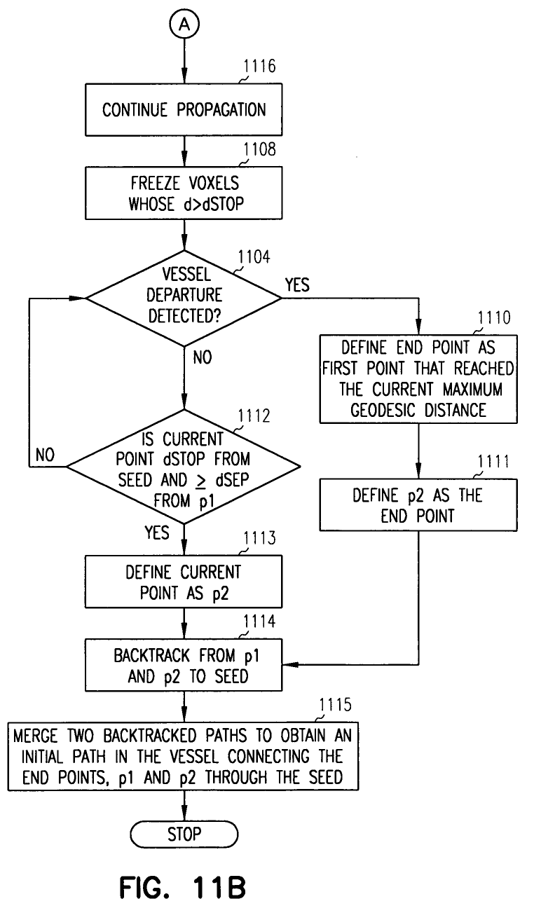

For each initial or further tubular data segmentation, an initial path through the vessel is first determined, such as by using the CVA centerline extraction techniques discussed above. This can be performed in a variety of ways. In one example, at 808, the user provides input specifying a path. In another example, the system automatically provides a path, such as by automatically selecting the path from: one or more previous CVA segments, stored reference information such as a human atlas, or any other path selection technique. In one example, the system calculates an initial path by tracking the vessel, such as described below with respect to FIGS. 10 and 11.

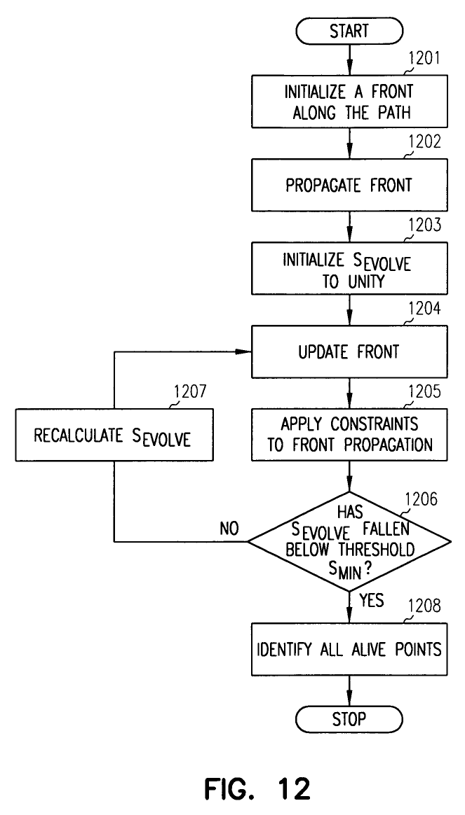

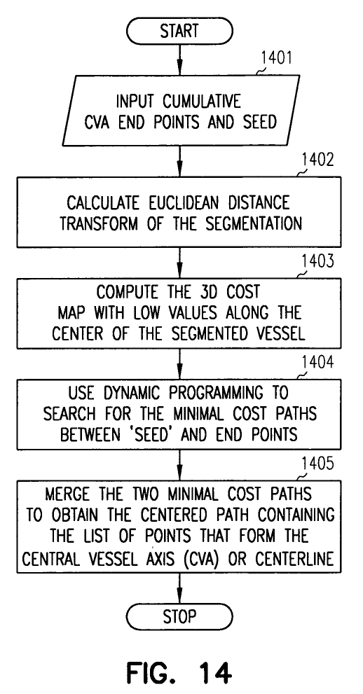

After obtaining the initial path at 807 or 808, tubular structure data segmentation is performed at 804, such as described below with respect to FIG. 12. After the vessel data is segmented to obtain the voxels associated with the vessel of interest, then, at 805, the CVA centerline associated with the vessel of interest is optionally corrected, such as by using the volumetric segmented vessel data. As an illustrative example of a need for such correction, the cumulative CVA extracted centerline segment may have endpoints that are located near the sidewalls of the vessel, as shown schematically in FIG. 17. This may result from a vessel that bends quickly. In another example, this may result from the CVA centerline extraction being allowed to propagate too far. If further CVA centerline extraction or vessel data segmentation is allowed to continue from endpoints that are inappropriately centered within this vessel, such processes may yield inaccuracies or failures. Therefore, the endpoints of the CVA centerline are corrected at 805 (using the segmented voxel data) to reposition the endpoints of the centerline toward the center of the vessel as calculated from the segmented voxel data. One example of endpoint correction is discussed below with respect to FIG. 14.

FIG. 9 is a flow chart illustrating generally, by way of example, but not by way of limitation, an example of acts associated with segmenting tubular voxel data. In this example, at 901, vessel gray value statistics are computed around the initial seed point. Various imaging modalities use different methods of representing different types of structures that are present in the imaged volume. Gray value statistics refer to just one possible representation of the image data. The gray values may vary significantly along the length of a single contrast-enhanced vessel. Re-initializing that includes recomputing the gray value statistics around each seed point permits the vessel data segmentation algorithm to adapt to the changing local values of gray values at different locations along the contrast-enhanced vessel. This allows the vessel data segmentation process to propagate further than if such local gray value statistics were not used at 901. Less propagation, by contrast, would require additional user intervention to obtain the desired segmented vessel data. In one example, the gray value statistics computed at 901 use Otsu's gray level threshold (Tᵥ) to separate the vessel from the background using the gray level distribution in a subvolume that is centered at the initial seed. This may also include estimation of the mean (μᵥ) and the standard deviation (sᵥ) of the gray level distribution of voxels in the subvolume having gray values between Otsu's threshold and a specified calcium threshold (T_{cal}).

At 902, a speed function is defined to be used in a level-set propagation method. See, e.g., Sethian, Level Set Methods and Fast Marching Methods, Cambridge University Press, 2^{nd} Ed., New York (1999). In general, a speed function can be defined using a variety of methods. Some examples are Hessian-based function, a gradient-based function, or gray level based function. However, a Hessian-based function is computationally expensive, which slows the data segmentation. Instead, in one example, the speed function is defined as a function of the gray level distribution computed around the seed point at 901. Different speed functions may be used for different vessel segments, or different portions of the same vessel segment. For example, if the vessel data is noisy, a different speed function may be used (e.g., switch over to Hessian) or a combination of different speed functions (e.g., both Hessian and gray level) could be used as well. In one example, a gray level speed function f(x) is used, where:
for x≧T_{cal}, f(x) is defined as:

$$f ( x ) = \frac{1}{1 + exp ( \frac{x - {μ}_{v}}{{σ}_{v}} )}$$
and for x<T_{cal}, f(x) is defined as:

$$f ( x ) = 1 - \frac{1}{1 + exp ( \frac{x - {μ}_{v}}{{σ}_{v}} )}$$

where x is the gray level, μᵥ is the mean of the vessel gray level distribution, and sᵥ is the standard deviation of the vessel gray level distribution.

At 903, an initial path is obtained, such as by using the initial seed point as the starting point, and using a vessel tracking algorithm based on wave front propagation solved using fast marching. This is described in more detail with respect to FIG. 10 and FIG. 11.

At 904, vessel data segmentation is performed using the centerline path obtained at 903, such as described below with respect to FIG. 12. After vessel data segmentation is performed, the centerline may be corrected using the segmented vessel data, as discussed above.

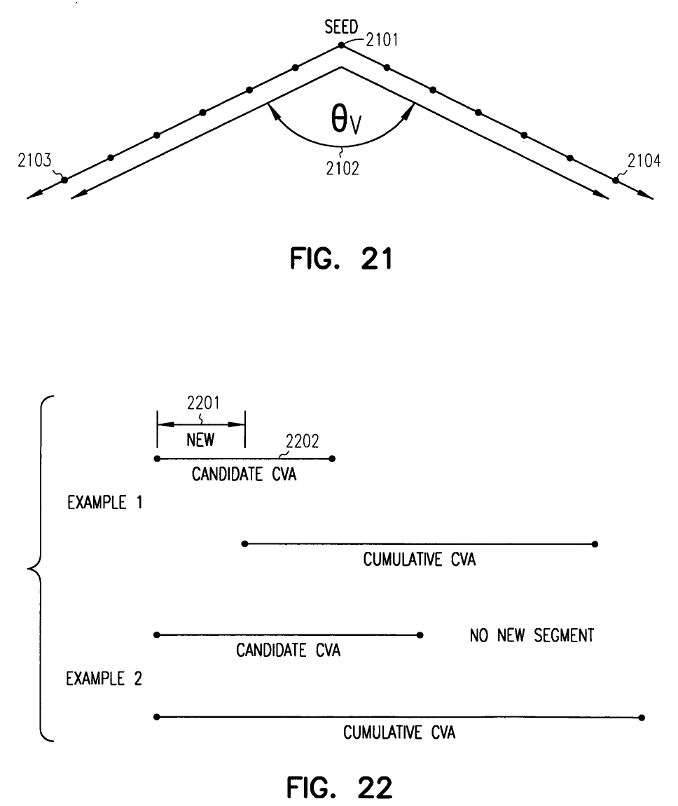

At 906, topological violations are optionally eliminated (unless, for example, it is desired to extract an entire vessel tree, in which case elimination of topological violations is not performed). One example of a topological violation is a Y-shaped centerline condition, such as is illustrated schematically in FIG. 21. Y-shaped centerline conditions may occur when the seed 2101 is ambiguous (such as near a bifurcation in the vessel). In such a case, the endpoints of the centerline may be located in different branches of the vessel. Detecting this condition involves finding the angle (?ₛ) 2102 subtended at the seed 2101 by the vectors from the seed 2101 to points on the centerline that are located a few extracted incremental segments away from the seed, as shown in FIG. 21 at 2103 and 2104. If the value of the angle 2102 is below a certain threshold (?ₘᵢₙ), then the propagation has resulted in a Y-shaped centerline.

As a first illustrative example, suppose that the portion of the centerline from 2101 to 2103 is the centerline of the vessel under investigation. According to the above-described topological violation elimination determination, the portion of the centerline from 2101 to 2104 would be a centerline of a different branch of the vessel that is not of interest.

As a second illustrative example, suppose that the portion of the centerline from 2101 to 2104 is the centerline of the vessel under investigation. According to the above-described topological violation elimination determination, the portion of the centerline from 2101 to 2103 would be a centerline of a different branch of the vessel that is not of interest.

In one example, the threshold (?ₘᵢₙ) is predetermined, such as to a default value, but which may vary (e.g., using a lookup table or a stored human body atlas), such as using a user-specified parameter identifying the vessel of interest or identifying the actual value of the threshold (?ₘᵢₙ).

FIG. 10 is a flow chart illustrating generally an example of a method of vessel tracking, such as for obtaining a CVA. At 1000, a wave-like front is initialized. At 1002, the front is propagated in a search direction of interest. This can be either a single direction (such as for the Single Direction Extraction at 507 of FIG. 5) or the first or second direction (such as for the Bi-Directional Extraction at 506 of FIG. 5), or one of multiple directions for multidirectional extraction. The front propagation may use fast marching, as discussed above. The length of the CVA incremental segment found during this part of the process will be no larger then a specified length (d_{segment}). Therefore, the endpoints of the CVA incremental segment will be no more then one half this length from the corresponding seed. Let dₛₜₒₚ refer to the maximum allowed distance between the corresponding seed and an end point of the CVA incremental segment. In one example, d_{segment} is pre-defined as part of a profile that is a function of the type of vessel being examined. After the front is initialized at 1001, it is propagated at 1002 until the current point of the front is located at a distance that is dₛₜₒₚ away from the corresponding seed 1003. At 1009, this current point of the front is defined as p₁, which is one of the endpoints of the CVA incremental segment. At 1007, given some predefined desired distance between endpoints, dₛₑₚ, another endpoint p₂ is found. In one example, p₂ is found by proceeding at 1008 from the seed point in the opposite direction from p₁ until, at 1012, another point is reached that is located at a distance that is dₛₜₒₚ and at least dₛₑₚ away from p₁. At 1013, this other point is defined as the other endpoint p₂ of the incremental CVA axis segment.

At 1014, the process backtracks from p₁ and p₂ to the seed to obtain two separate paths. In one example, this is accomplished using a L1 descent that follows the minimum cost path among the six connected neighbors on a 3D map containing the order of operation. At 1015, merging the two backtracked paths obtains an initial path in the vessel connecting points p₁ and p₂ through the seed.

FIG. 11 is a flow chart illustrating generally an example of a vessel tracking method substantially similar to FIG. 10. At 1104, during front propagation, a vessel departure check is performed to determine whether the vessel segment terminates, branches, and/or empties into a larger vessel or body (such as a blood vessel arriving at a heart chamber, for example). One example of the vessel departure check is described further below with respect to FIG. 15. If a vessel departure is detected while the current point on the propagating front is still less then dₛₜₒₚ away from the seed then, at 1105, that departure point is defined as the endpoint of the CVA incremental segment p₁. Otherwise, the front is propagated until, at 1103, a current point on the front is a distance dₛₜₒₚ away from the seed; at 1109, that current point is declared as the endpoint p₁.

Regardless of whether it is obtained as the result of vessel departure, at 1106, or as a result of propagation to dₛₜₒₚ, at 1109, p₁ is one of the endpoints of the CVA incremental segment. Given a specified distance between endpoints, dₛₑₚ 1107 the other endpoint can be located by propagating from the seed point in the opposite direction from that just examined until it finds another point that is d_{stop which is as well at least d}ₛₑₚ away from p₁ 1112.

In one example, at 1108, all voxels with a distance from the seed that exceeds dₛₜₒₚ are frozen. This prevents further propagation in the direction of p₁, which increases computational efficiency.

FIG. 12 is a flow chart illustrating generally one example of a vessel or other tubular data segmentation method. Given an initial path through the vessel (e.g., a centerline obtained using the cumulative CVA extraction described elsewhere in this document) the vessel segmentation obtains voxels associated with the corresponding 3D vessel structure. In various examples, the initial path is given by user-input, automatic input, and/or calculated by vessel tracking. In one example, the vessel data segmentation uses front propagation techniques, such as described with respect to FIGS. 10 and 11 (with or without vessel departure detection).

In this example, at 1201, using a previously determined initial path through the vessel, a front is initialized, such as at the initial seed point. At 1202, the front is propagated until its speed of evolution (Sₑᵥₒₗᵥₑ) falls below a predetermined threshold (Sₘᵢₙ) at 1206. This checks against a vessel departure. For example, in the case of a 3D blob, the corresponding Sₑᵥₒₗᵥₑ of the front is initially fast as the front proceeds out from the seed point 1601 as depicted in FIG. 16. As the front approaches the vessel sidewall 1606, Sₑᵥₒₗᵥₑ will begin to decrease. As the front begins to propagate axially along the vessel, such as in the direction 1605, Sₑᵥₒₗᵥₑ will be fast. If the vessel ends, the front's propagation speed decreases. If the vessel opens into a larger vessel or body, such as depicted in FIG. 18, the value of Sₑᵥₒₗᵥₑ as the front approaches 1803 will be low and, moreover, will not recover as in the case of a tubular structure such as that of FIG. 16. Thus, the constraint on Sₑᵥₒₗᵥₑ during vessel segmentation prevents vessel departure.

At 1203, Sₑᵥₒₗᵥₑ is initialized to unity. Sₑᵥₒₗᵥₑ is re-calculated, at 1207, after every front update 1208, such as by using the following equation:
Sₑᵥₒₗᵥₑ(new)=W_{old}·Sₑᵥₒₗᵥₑ(old)+W_{new}·Sᵥₒₓₑₗ
where Sᵥₒₓₑₗ is the speed of the voxel being updated and W_{old} and W_{new} are fixed weights on the current speed of evolution and the voxel speed, respectively. The front evolves by adding new voxels to it. A variety of constraints may be applied to the front propagation. At 1205, one such constraint freezes those voxels in the front that are beyond a certain distance (dₑᵥₒₗᵥₑ) from its origin, where the origin is the voxel in the initial front that spawned the predecessors of this voxel. Freezing voxels prevents the front from propagating in that direction. In one example, devolve is selected to be slightly greater then the maximum radius of the vessel. In one example, devolve is predefined as part of a vessel profile selected by the user. The points in the dataset have one of three states: (I) “alive,” which refers to points that the front has traveled to; (2) “trial,” which refers to neighbors of “alive” points; and (3) “far,” which refers to points the front hasn't reached. At the end of front propagation all the “alive” points in the front give the segmentation data for the vessel at 1207.

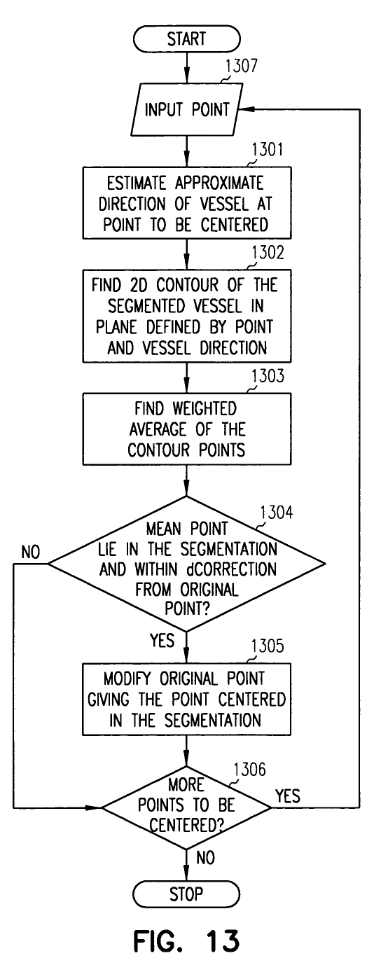

FIG. 13 is a flow chart illustrating generally one example of a centering method. Although the end points of an incremental or cumulative CVA may be used as seeds for further CVA extractions, FIG. 17 illustrates an example of how this may lead to detrimental results. In FIG. 17, using the end points 1702 and 1703 as seeds for further propagation may promote failures in such further propagation. FIG. 13 illustrates one corrective technique. In one example, this technique is performed for each CVA point to be centered. In another example, such centering is restricted to the end points, p₁ and p₂, and/or the seed point.

At 1301, the approximate direction of the vessel at the point to be centered is estimated 1301, such as from the Eigen vectors of the Hessian matrix. The eigen vector that corresponds to the eigen value with the smallest value gives this direction. The CVA points are to be re-centered using the 2D contour of the segmented 3D vessel. At 1303, a weighted average of the contour points is found, such as by using ray casting techniques. In one example the contour points are given by a 2D contour at 1302. At 1304, a determination is made of whether the mean point in the weighted average lies in the segmentation and is also within a certain predefined distance threshold (d_{correction}) from the original point. If so, at 1305, the original point is re-centered using this mean point.

FIG. 14 is a flow chart illustrating generally one example of path centering during the entire CVA extraction. Given a list of cumulative CVA points, the endpoints, p₁ and p₂, and the initial seed point, and the centered path passing through these three points can be found. By first calculating the Euclidean distance transform of the segmentation, at 1402, a minimum Euclidean distance is obtained from every voxel to a background voxel. At 1403, a 3D cost map is computed (with low values being along the center of the segmented vessel), such as by using the transformation:

$$c ( x , y , z ) = \frac{1}{1 + α ∘ {d ( x , y , z )}^{β}}$$

where c(x,y,z) and d(x,y,z) are the respective cost and the Euclidean distance transform values at a given voxel and ∝ and β are constants that control smoothness. At 1404, dynamic programming is used to search for the minimal cost paths between the seed and the end points p₁ and p₂. At 1405, merging these two minimal cost paths yields the centered path. This centered path contains the list of points that form the central vessel axis or centerline.

FIG. 15 is a flow chart illustrating generally one example of vessel departure detection. In one example, a vessel departure check is performed after every front update while propagating the front for determining p₁ or p₂. After every front update, the maximum geodesic distance (dₘₐₓ) of any point in front of the seed is calculated. When vessel departure is detected, the front propagation is terminated immediately. The first point reaching the maximum geodesic distance at vessel departure is considered the end point.

The vessel departure check uses a cylindrical model of the vessel, which is completely characterized by its radius (r) and height (h). The approximate diameter of the vessel at the seed is estimated at 1502 using Principal Component Analysis (PCA). The maximum geodesic distance increases monotonically after every update and is approximately equal to one half the height of the cylinder (i.e., h=2·dₘₐₓ). At 1503, vessel departure occurs when the rate (R) at which the height increases falls below a predetermined threshold (Rₘᵢₙ). The rate R is the ratio of the increase in maximum geodesic distance (? dₘₐₓ) and the front iteration interval (? i) over which the increase has been observed. In one example, the iteration interval is calculated adaptively based on the current value of dₘₐₓ and the total number of updates:
Interval ? i=Nᵤ=N_{c}−N_{f}
where Nᵤ is the number of unfilled voxels in the cylinder, N_{c} is the estimated total number of voxels in the cylinder and N_{f} is the number of filled voxels. N_{f} is given by the total number of iterations and N_{c} is calculated as:
N_{c}=Volume of cylinder/Volume per voxel
Volume of cylinder=2pr²dₘₐₓ

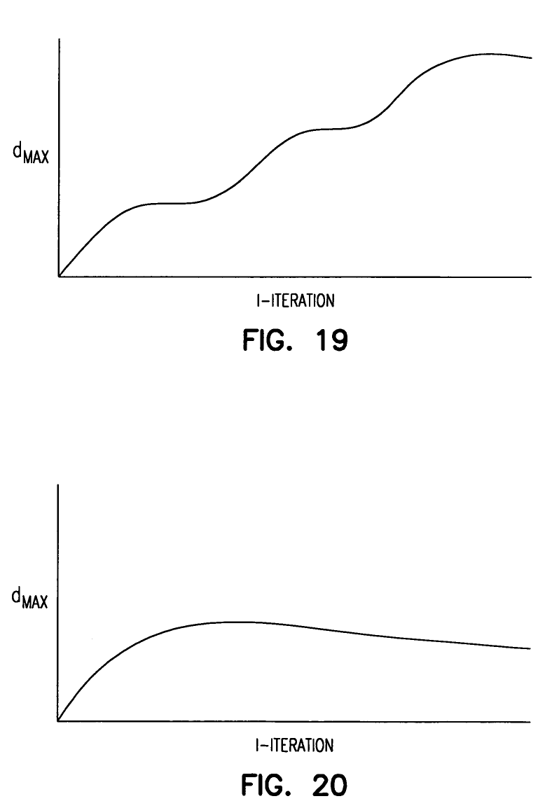

FIG. 19 and FIG. 20 depict the expected dₘₐₓ values as a function of the front iteration. After every iteration in a tubular structure, dₘₐₓ should increase until such time as the front reaches the vessel sidewall. The dₘₐₓ will then flatten out for a period, but as the front propagate outwards dₘₐₓ will begin to increase again. This can be represented by the stepped nature of the graph. In the case of a 3D blob (where the front propagates out in all directions at once) this graph will rise at first but then flatten out. By watching for the characterization of the dₘₐₓ increases, the departure from the vessel into a non-tubular structure can be detected.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. Functions described or claimed in this document may be performed by any means, including, but not limited to, the particular structures described in the specification of this document. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

1. A computer-assisted method comprising:
accessing stored volumetric (3D) imaging data of a subject;
representing at least a portion of the 3D imaging data on a two dimensional (2D) screen;
receiving user-input specifying a single location on the 2D screen;
computing an initial centerline path of the tubular structure;
obtaining segmented 3D tubular structure data by performing a segmentation that separates the 3D tubular structure data from other data in the 3D imaging data using the single location as an initial seed for performing the segmentation; and
correcting the initial centerline path using the segmented 3D tubular structure data.

2. The method of claim 1, further comprising incrementally extracting from the 3D imaging data a central axis path of the tubular structure.

3. The method of claim 2, in which the performing the segmentation further comprises:
initializing a front at an origin that is located along the central axis path;
initializing a propagation speed of evolution of the front to a first value;
propagating the front by iteratively updating the front, the updating including recalculating the propagation speed;
comparing the propagation speed to a predetermined threshold value that is less than the first value;
if the propagation speed falls below the predetermined threshold value, then terminating the propagating of the front; and
classifying all points that the front has reached as pertaining to the tubular structure.

4. The method of claim 1, further comprising:
initializing at least one parameter of a segmentation algorithm;
iteratively performing the segmentation of 3D tubular structure data for separating the 3D tubular structure data from other data in the 3D imaging data, the iteratively performing the segmentation including iterating the segmentation algorithm; and
reinitializing the at least one parameter between iterations of the segmentation algorithm, the reinitializing including adjusting the at least one parameter to accommodate a local variation in data associated with the tubular structure.

5. The method of claim 1, further comprising:
computing a central vessel axis (CVA) of the segmented 3D tubular structure;
representing a 3D image of a region near the segmented 3D tubular on a two dimensional (2D) screen;
displaying on the screen a first lateral view of at least one portion of the segmented 3D tubular structure, the first lateral view obtained by performing curved planar reformation on the CVA of the segmented 3D tubular structure;
displaying on the screen a second lateral view of the at least one portion of the segmented 3D tubular structure, the second lateral view taken perpendicular to the first lateral view;
displaying on the screen cross sections, perpendicular to the CVA; and
wherein the 3D image, the first and second lateral views, and the cross sections are displayed in visual correspondence together on the screen.

6. The method of claim 1, further comprising masking data that is outside of the 3D tubular structure.

7. The method of claim 1, further comprising computing at least one estimated diameter of the segmented 3D tubular structure.

8. The method of claim 7, further comprising flagging at least one location of the segmented 3D tubular structure, the at least one location deemed to exhibit at least one of a stenosis or an aneurysm.

9. The method of claim 7, further comprising displaying the segmented 3D tubular structure using a color-coding to indicate the diameter.

10. The method of claim 1, further comprising displaying the segmented 3D tubular structure in a manner that mimics a conventional angiogram.

11. A computer-readable medium including executable instructions for performing a method, the method comprising:
accessing stored volumetric (3D) imaging data of a subject;
representing at least a portion of the 3D imaging data on a two dimensional (2D) screen;
receiving user-input specifying a single location on the 2D screen;
computing an initial centerline path of the tubular structure;
obtaining segmented 3D tubular structure data by performing a segmentation that separates the 3D tubular structure data from other data in the 3D imaging data using the single location as an initial seed for performing the segmentation; and
correcting the initial centerline path using the segmented 3D tubular structure data.

12. A computer-assisted method comprising:
accessing stored volumetric (3D) imaging data of a subject;
initializing at least one parameter of a volumetric segmentation algorithm;
iteratively performing a segmentation to separate 3D tubular structure data from other data in the 3D imaging data, the iteratively performing the segmentation including iterating the segmentation algorithm; and
reinitializing the at least one parameter between iterations of the segmentation algorithm, the reinitializing including adjusting the at least one parameter if needed to accommodate a local variation in the 3D tubular structure data.

13. The method of claim 12, further comprising:
receiving user input specifying a single location;
computing a central vessel axis (CVA) path using the single location as an initial seed; and
wherein the iteratively performing the segmentation includes using the CVA path to guide the segmentation.

14. The method of claim 12, further comprising:
automatically computing a single location to use as an initial seed;
computing a central vessel axis (CVA) path using the automatically computed single location as the initial seed; and
wherein the iteratively performing the segmentation includes using the CVA path to guide the segmentation.

15. The method of claim 14, in which the automatically computing the single location comprises using a stored atlas of 3D imaging information to obtain the single location.

16. The method of claim 12, further comprising masking data that is outside of the 3D tubular structure.

17. The method of claim 12, further comprising computing at least one estimated diameter of the segmented 3D tubular structure.

18. The method of claim 17, further comprising flagging at least one location of the segmented 3D tubular structure, the at least one location deemed to exhibit at least one of a stenosis or an aneurysm.

19. The method of claim 17, further comprising displaying the segmented 3D tubular structure using a color-coding to indicate the diameter.

20. The method of claim 12, further comprising displaying the segmented 3D tubular structure in a manner that mimics a conventional angiogram.

21. A computer readable medium including executable instructions for performing a method, the method comprising:
accessing stored volumetric (3D) imaging data of a subject;
initializing at least one parameter of a volumetric segmentation algorithm;
iteratively performing a segmentation to separate 3D tubular structure data from other data in the 3D imaging data, the iteratively performing the segmentation including iterating the segmentation algorithm; and
reinitializing the at least one parameter between iterations of the segmentation algorithm, the reinitializing including adjusting the at least one parameter if needed to accommodate a local variation in the 3D tubular structure data.

22. A computer-assisted method of performing a segmentation of 3D tubular structure data from other data in 3D imaging data, the method comprising:
initializing a wave-like front at an origin that is located along a path of interest in the 3D imaging data;
initializing a propagation speed of evolution of the front to a first value;
propagating the front by iteratively updating the front, the updating including recalculating the propagation speed;
comparing the propagation speed to a predetermined threshold value that is less than the first value;
if the propagation speed falls below the predetermined threshold value, then terminating the propagating of the front; and
classifying all points that the front has reached as pertaining to the tubular structure.

23. The method of claim 22, further comprising constraining the front to prevent propagation beyond a predetermined distance from the origin.

24. The method of claim 22, further comprising receiving user input to specify a single location as the origin.

25. The method of claim 22, further comprising determining the path of interest using an atlas of stored 3D human body imaging information.

26. The method of claim 22, further comprising:
initializing at least one parameter associated with the front;
iteratively propagating the front until a termination criterion is met; and
reinitializing the at least one parameter between the iterations, the reinitializing including adjusting the at least one parameter to accommodate a local variation in data associated with the tubular structure.

27. A computer readable medium including executable instructions for performing a method, the method comprising:
initializing a wave-like front at an origin that is located along a path of interest in the 3D imaging data;
initializing a propagation speed of evolution of the front to a first value;
propagating the front by iteratively updating the front, the updating including recalculating the propagation speed;
comparing the propagation speed to a predetermined threshold value that is less than the first value;
if the propagation speed falls below the predetermined threshold value, then terminating the propagating of the front; and
classifying all points that the front has reached as pertaining to the tubular structure.

28. A computer-assisted method comprising:
obtaining volumetric three dimensional (3D) imaging data of a subject;
computing a central vessel axis (CVA) of at least one vessel of interest;
performing a segmentation to separate data associated with the at least one vessel of interest from other data in the 3D imaging data of the subject to obtain segmented data that is associated with a segmented vessel structure;
representing a 3D image of a region of the 3D imaging data on a two 8 dimensional (2D) screen;
displaying on the screen a first lateral view of at least one portion of the at least one vessel of interest;
displaying on the screen a second lateral view of the at least one portion of the at least one vessel of interest, the second lateral view taken perpendicular to the first lateral view; and
displaying on the screen cross sections, perpendicular to the CVA; and
wherein the 3D image, the first and second lateral views, and the cross sections are displayed in visual correspondence together on the screen.

29. The method of claim 28, further comprising obtaining the first lateral view by performing curved planar reformation on the CVA of the segmented vessel structure.

30. The method of claim 28, further comprising choosing a direction of the first lateral view to obtain a substantial minimum of curvature of the vessel of interest in an elongated window displaying the first lateral view.

31. The method of claim 30, in which the choosing the direction includes performing Principal Components Analysis (PCA).

32. The method of claim 28, further comprising receiving user input specifying a single location as an origin for at least one of the computing the CVA and the performing the segmentation.

33. The method of claim 28, further comprising specifying the at least one vessel of interest using an atlas of stored 3D human body imaging information.

34. The method of claim 28, in which the performing the segmentation includes:
initializing at least one parameter of a segmentation algorithm;
iteratively performing the segmentation to separate data associated with a 3D tubular structure from other data in the 3D imaging data, the iteratively performing the segmentation including iterating the segmentation algorithm; and
reinitializing the at least one parameter between iterations of the segmentation algorithm, the reinitializing including adjusting the at least one parameter to accommodate a local variation in data associated with the tubular structure.

35. The method of claim 28, in which the performing the segmentation comprises:
initializing a wave-like front at an origin that is located along the CVA;
initializing a propagation speed of evolution of the front to a first value;
propagating the front by iteratively updating the front, the updating including recalculating the propagation speed;
comparing the propagation speed to a predetermined threshold value that is less than the first value;
if the propagation speed falls below the predetermined threshold value, then terminating the propagating of the front; and
classifying all points that the front has reached as pertaining to the tubular structure.

36. The method of claim 28, further comprising masking data that is outside of the vessel of interest.

37. The method of claim 28, further comprising computing at least one estimated diameter of the segmented vessel of interest.

38. The method of claim 37, further comprising flagging at least one location of the segmented vessel of interest, the at least one location deemed to exhibit at least one of a stenosis or an aneurysm.

39. The method of claim 37, further comprising displaying the segmented vessel of interest using a color-coding to indicate the diameter.

40. The method of claim 28, further comprising displaying the segmented vessel of interest in a manner that mimics a conventional angiogram.

41. The method of claim 28, in which the displaying on the screen cross sections includes displaying an array of cross-sections that are equally spaced apart on the CVA.

42. The method of claim 41, further comprising:
displaying a cursor that is manipulable to travel along a view of the vessel of interest; and
in which the array of cross-sections is centered around a location of the cursor.

43. A computer readable medium including executable instructions for performing a method, the method comprising:
obtaining volumetric three dimensional (3D) imaging data of a subject;
computing a central vessel axis (CVA) of at least one vessel of interest;
performing a segmentation to separate data associated with the at least one vessel of interest from other data in the 3D imaging data of the subject to obtain segmented data that is associated with a segmented vessel structure;
representing a 3D image of a region of the 3D imaging data on a two dimensional (2D) screen;
displaying on the screen a first lateral view of at least one portion of the at least one vessel of interest;
displaying on the screen a second lateral view of the at least one portion of the at least one vessel of interest, the second lateral view taken perpendicular to the first lateral view; and
displaying on the screen cross sections, perpendicular to the CVA; and
wherein the 3D image, the first and second lateral views, and the cross sections are displayed in visual correspondence together on the screen.
